(19) United States
(12) Patent Application Publication
(10) Pub. No.: US 2015/0339937 A1
(43) Pub. Date: Nov. 26, 2015

(54) METHODS AND SYSTEMS FOR TESTING WITH TEST BOOKLETS AND ELECTRONIC DEVICES

(71) Applicant: ACT, Inc., Iowa City, IA (US)

(72) Inventor: Bradley Martin, Monkton, MD (US)

(73) Assignee: ACT, Inc., Iowa City, IA (US)

(21) Appl. No.: 14/284,996

(22) Filed: May 22, 2014

(51) Int. Cl. G09B 7/00; G09B 3/00

(52) U.S. Cl. CPC G09B 7/00; G09B 3/00

(57) ABSTRACT

Methods and systems for testing with test booklets and electronic devices are disclosed. In one aspect, a computer-assisted testing method and system is provided. A paper-delivered examination is used and includes an examination booklet and a plurality of test items. Solutions are entered into an electronic answer sheet for the test items in the examination booklet. An electronic attendance request from a student can be confirmed by granting the student access to an electronic response sheet corresponding to the paper-delivered exam. Student responses to the plurality of test items in the paper-delivered exam can be entered in the electronic response sheet.

### FIELD OF THE INVENTION

The present invention relates to methods and systems for testing with test booklets and electronic devices. More specifically, but not exclusively, the present invention relates to methods and systems for using paper test booklets while electronically capturing item responses.

### DESCRIPTION OF THE PRIOR ART

Conversion of conventional testing practices (e.g., “pencil and paper” test) to computer-based testing (“CBT”) has its disadvantages. For example, rendering test item content in a digital format or form for making real-time scoring a possibility can be cost prohibitive.

Therefore, it is an object, feature, or advantage of the present invention to provide methods and systems for computer-based testing that continue to use paper examination booklets.

Another object, feature, or advantage of the present invention is to provide methods and systems for using paper examination booklets while incorporating a digital replacement for capturing item responses.

A still further object, feature, or advantage of the present invention is to provide methods and systems for using paper answer booklets while providing real-time scoring at a fraction of the cost for rendering item content on a digital device.

A still further object, feature, or advantage of the present invention is to provide methods and systems for testing with test booklets and electronic devices that enable a rapid conversion to computer-based testing from current paper and pencil tests while avoiding the large cost associated with total migration of item content to computer-based testing.

One or more of these and/or other objects, features, or advantages of the present invention will become apparent from the specification and claims that follow.

### SUMMARY OF THE INVENTION

The present invention provides methods and systems for testing with test booklets and electronic devices.

One exemplary embodiment provides a computer-assisted testing method. In one aspect, a paper exam is provided and an electronic answer sheet is created. Solutions for the paper exam are entered into the electronic answer sheet, such as a by a test administrator. The paper exam is marked with a test identifier for associating the paper exam with the electronic answer sheet.

Another exemplary embodiment provides a computer-assisted testing method. In one aspect of the method, a paper exam is provided to an examinee. The paper exam includes at least one type of an identifier. An electronic answer sheet is accessed using the identifier associated with the paper exam. Answers to questions taken from the paper exam are entered into the electronic answer sheet.

Another exemplary embodiment provides a computer-assisted testing method. According to one aspect, a paper-delivered examination is provided, which includes an examination booklet with a plurality of test items. Solutions are entered into an electronic answer sheet corresponding to the plurality of test items in the examination booklet. A QR code label is printed and affixed to the examination booklet. The QR code label is scanned to access an electronic answer sheet corresponding to the examination booklet. Responses to the plurality of test items in the examination booklet are selected on the electronic answer sheet.

### BRIEF DESCRIPTION OF THE DRAWINGS

Illustrative embodiments of the present invention are described in detail below with reference to the attached drawing figures, which are incorporated by reference herein, and wherein:

FIG. 1 is a pictorial representation of a flow chart for paper and device operations in accordance with an illustrative embodiment;

FIG. 2 is a pictorial representation of a flow chart for pre-administration operations in accordance with an illustrative embodiment;

FIG. 3 is a pictorial representation of a flow chart for examination operations in accordance with an illustrative embodiment;

FIG. 4 is a pictorial representation of post-administration operations in accordance with an illustrative embodiment;

FIGS. 5A-C are pictorial representations of a flow diagram for testing with test booklets and electronic devices in accordance with an illustrative embodiment;

FIG. 6 is a pictorial representation of a block diagram for a student application process in accordance with an illustrative embodiment;

FIG. 7 is a pictorial representation of a block diagram for a teacher application process in accordance with an illustrative embodiment;

FIGS. 8A-8G are pictorial representations of screen shots for a student application in accordance with an illustrative embodiment;

FIGS. 9A-9L are pictorial representations of screen shots for a teacher application in accordance with an illustrative embodiment; and

FIG. 10 is a pictorial representation of a block diagram for a computer network and system in which an embodiment of the invention may be implemented in accordance with an illustrative embodiment.

### DETAILED DESCRIPTION OF THE PREFERRED EMBODIMENTS

Methods and systems for testing with test booklets and electronic devices are disclosed. According to one aspect, conventional item response capturing, typically captured using a pencil and paper answer sheet, is migrated to a computer-based test delivery process using, for example, a tablet device or computer connected to the internet and/or one or more networks. As computer-based test delivery is defined traditionally as “a test taken by a student on a computer and scored by a computer,” aspects of the disclosure provide migration of computer-based test delivery resulting in real-time scoring at a fraction of the cost of rendering item content on a digital or otherwise electronic device. Therefore, the use of paper test booklets and electronically captured item responses for pre and post administrative scoring are contemplated by one or more of the methods and systems of the present invention.

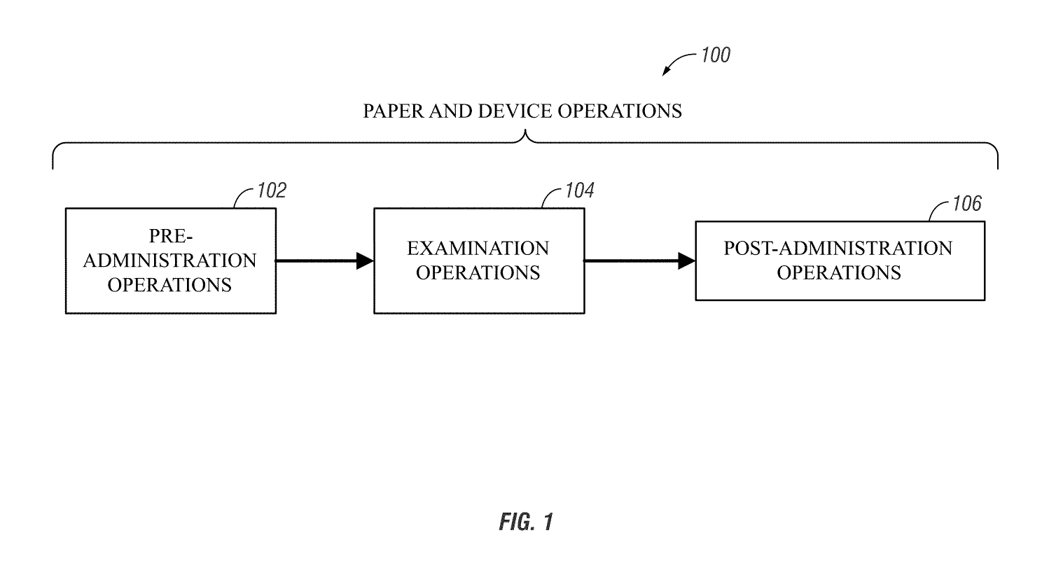

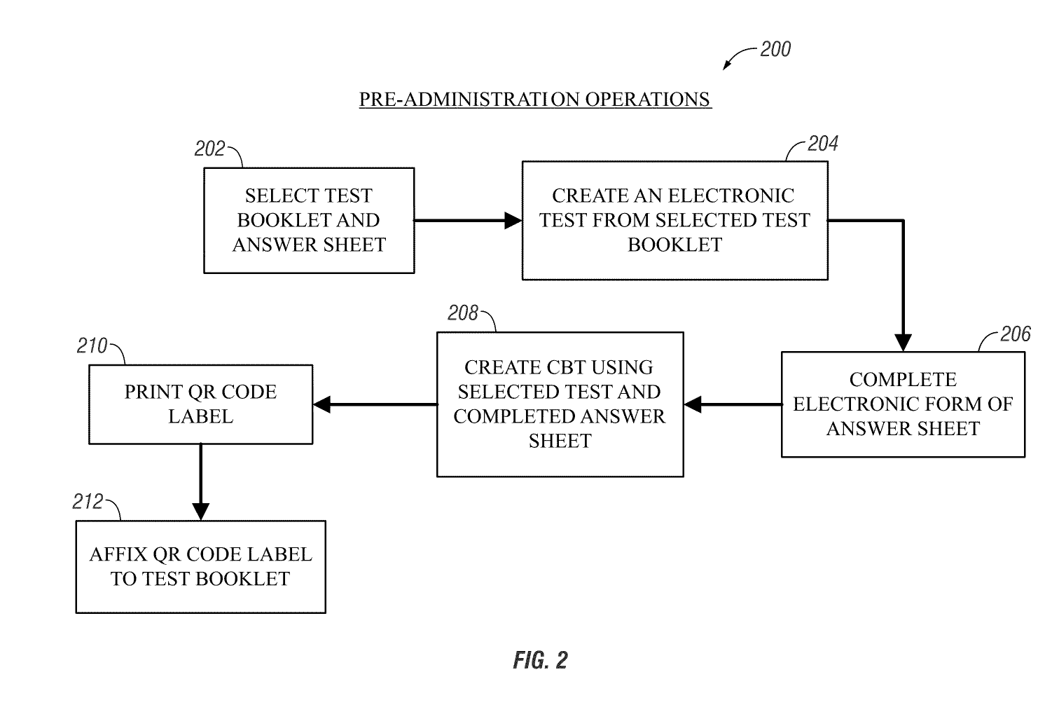

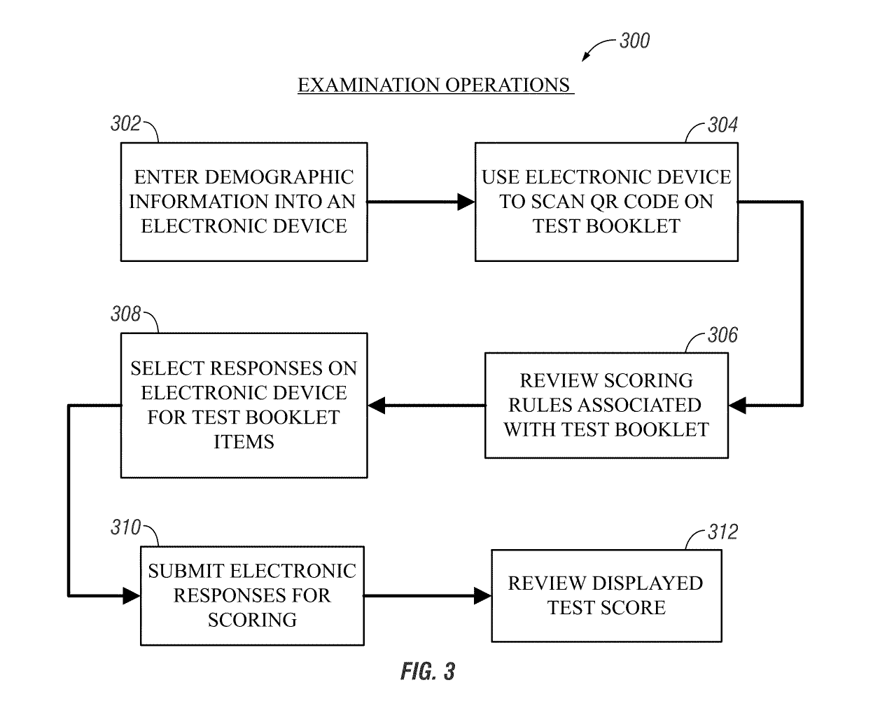

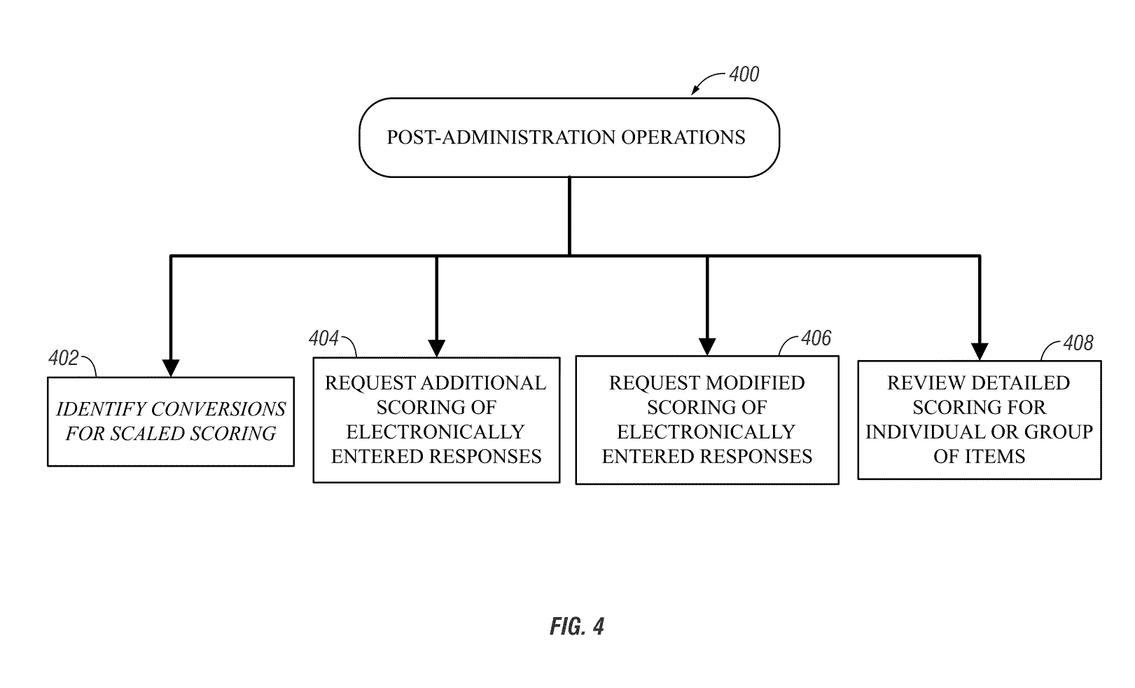

As pictorially represented in FIG. 1, paper and device operations 100 of the present invention include, for example, pre-administration operations 102, examination operations 104, and post-administration operations 106. Other operations are contemplated as may be administered or otherwise suitable for the methods and systems of the invention that provide for testing with test booklets and electronic devices. Additional details regarding contemplated pre-administration operations 200 are disclosed pictorially in FIG. 2, examination operations 300 are disclosed pictorially in FIG. 3 and post-administration operations 400 are disclosed pictorially in FIG. 4.

FIG. 2 is a pictorial illustration of exemplary pre-administration operations 200 according to an illustrative embodiment. One or more of the following operations may be performed by an administrator's proctor or like personnel. As is typical with a testing event, a test booklet and answer sheet is selected 202 commensurate with the testing event. This includes, for example, selecting a paper test booklet and an accompanying answer sheet or plurality of answer sheets associated with the paper test booklet. Using an electronic device, such as a computing device, computing tablet, or other like electronic controller, an administrator creates a “new test” associated with the paper test booklet and accompanying answer sheet 204. The administrator or other personnel enters the solutions or correct answers by digitally filling out an electronic answer sheet associated with the paper test booklet 206. Upon completion of the test (i.e., entering all the correct responses or solutions) an option may be provided for the administrator or other personnel to create a computer-based test 208. The electronic or computing device in which the solutions or answers are entered by the administrator or other personnel may be configured to communicate directly or wirelessly with a computing network. The network may utilize one or more computing communication standards, such as 802.11_{—} (e.g., 802.11n) as the standard continues to be updated. Direct or indirect communications may include, for example, Bluetooth, ZigBee, WiFi, wireless local area network (WLAN), WiMAX, proprietary standards, or other radio frequency signals whether analogue or digital that may be utilized to communicate a signal to/from the computing or electronic device. Any number of FCC, FDA, IEEE, ISO, CEN, ETSI, ARIB, and CANSI, or IEC approved communication protocols or standards may also be transmitted to/from the electronic device or computing device. Indeed, the types of wireless or wire standards or methods of communication are numerous. The electronic device or computing device may also act as a server to deliver or save content to any number of other client devices, systems, equipment, streaming configurations, or databases. The electronic device or computing device may be configured to transmit data (e.g., a newly created test) to/from a data store, database, server, network or other like elements.

Upon completion of an electronic form of the answer sheet, the administrator or other personnel may print a quick response (“QR”) code label 210 to affix, adhere to or otherwise associate with the paper test booklet 212. According to one aspect of the invention, the QR code label associates the electronic answer solution with the specific paper test booklet to which the QR code label is affixed or adhered. The data associated with the printed QR code label may be stored, retrieved, transmitted or otherwise handled in any manner as previously described. According to an aspect of the invention, upon affixing or adhering a QR code label to a paper test booklet 212, the booklet is then distributed to an Examinee (e.g., such as by an administrator or proctor) for use as an examination test booklet. Alternatively, an Examinee may perform one or more of these steps where appropriate.

One or more examination operations 300 are provided and pictorially represented in FIG. 3. Upon receipt of a paper test booklet with a QR code label, an Examinee, using an electronic device, enters demographic information for identification purposes 302. For example, the Examinee may enter his/her first and last name and other information relating to or for identifying the Examinee. Using the electronic device or some other preferable electronic platform, the Examinee may scan, take a picture of or optically identify the QR code affixed to or adhered to the paper test booklet 304. The electronic device may be configured to retrieve the data associated with the QR code label from a network, data store or location remote to or local to the electronic device by using any one or more of the aforementioned protocols or operations. For example, the specific scoring rules associated with the paper test booklet may be retrieved, identified and reviewed (e.g., displayed) to the Examinee 306. Using the paper test booklet and electronic device, the Examinee proceeds with the examination process by digitally selecting responses for one or more or all items in the paper test booklet 308. For example, the Examinee would enter his/her responses into an electronic answer sheet made available or otherwise displayed by the electronic device. Thus, test booklet items in a paper test booklet are answered or responses for the test booklet items are responded to by entering the responses into an electronic answer sheet (i.e., digitally selecting responses for test items in a paper-delivered examination test booklet). Upon completion of the exam, the Examinee is able to submit the responses electronically for immediate scoring 310 and optional review of the responses beforehand. A raw score or other like metric may be displayed 312 for the Examinee to inspect and review in real-time based on scored items from items in a paper-delivered test examination booklet.

FIG. 4 is a pictorial illustration of one or more post-administration operations 400 in accordance with an illustrative embodiment of the disclosure. Receiving entered responses, scoring responses and evaluating other response considerations relating to the items in the test can be performed in real-time as responses are entered or solutions are entered into the electronic device. Amongst other operations, an administrator or like personnel could use real-time scoring of the examination to identify conversions for scaled scoring processes 402, request additional scoring of electronically entered responses 404, request modified scoring of electronically entered responses 406, and/or review detailed scoring for an individual or group of test items 408. The real-time acquisition of examination responses allows the administrator to perform these and/or other like post-administration operations 400.

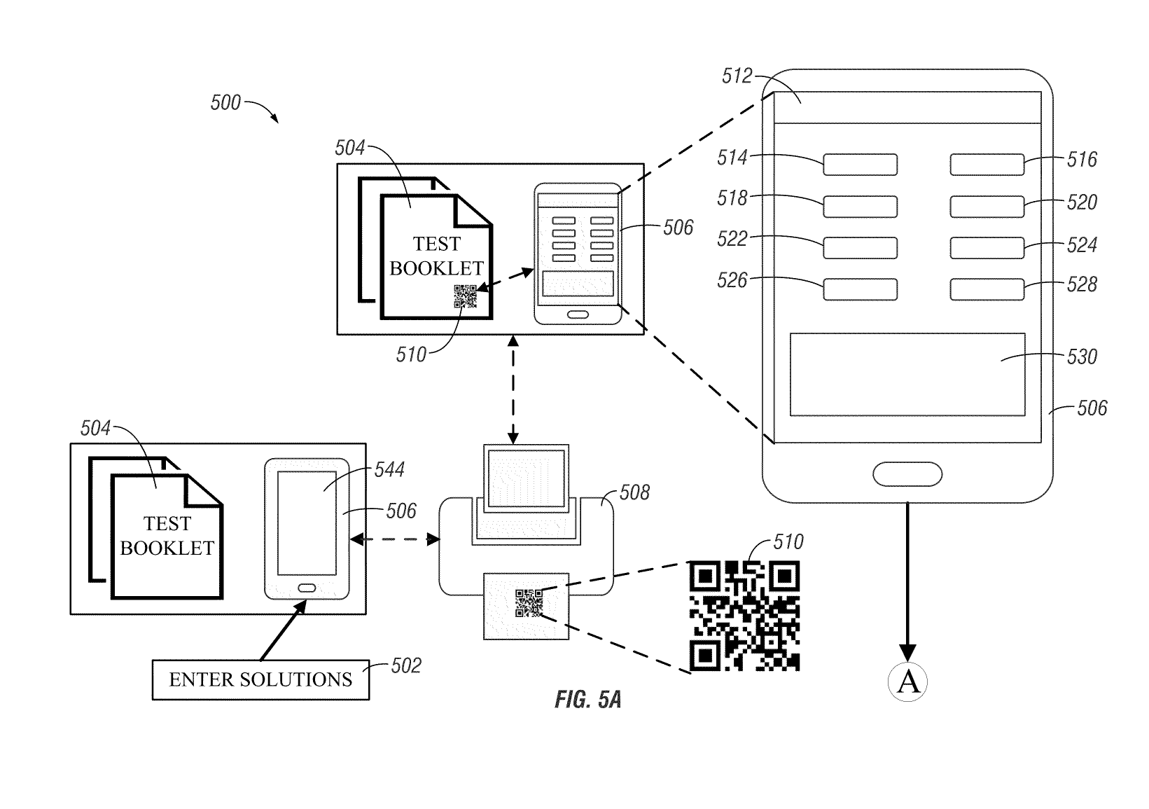

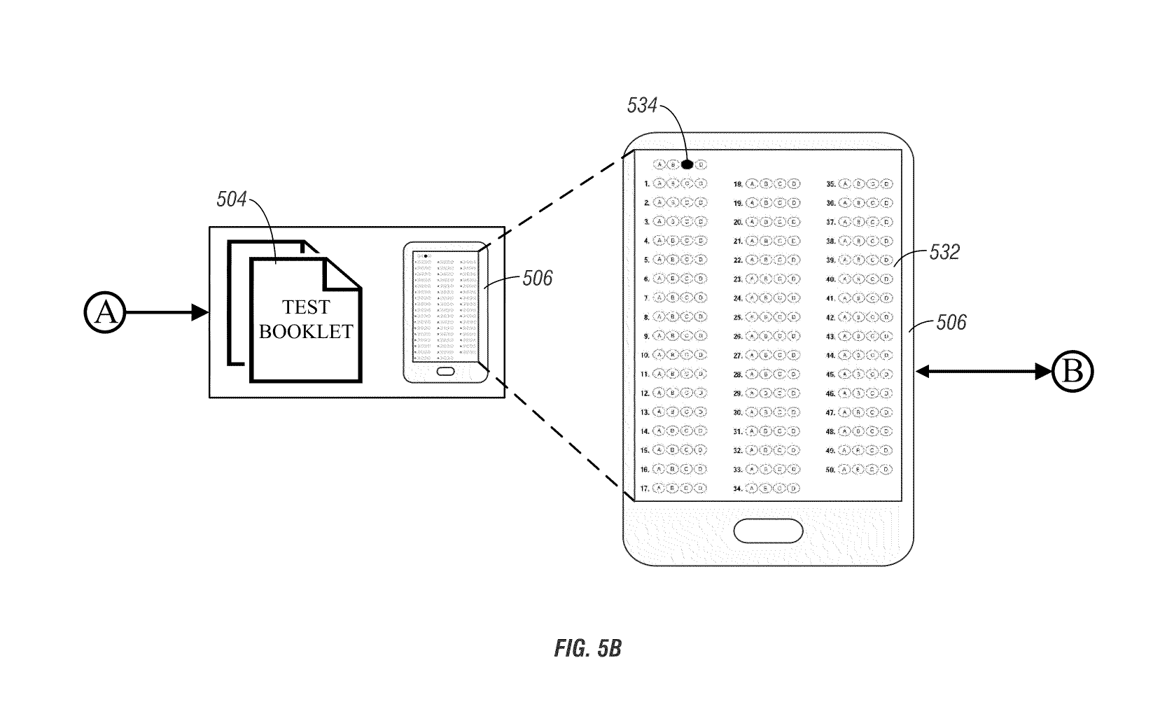

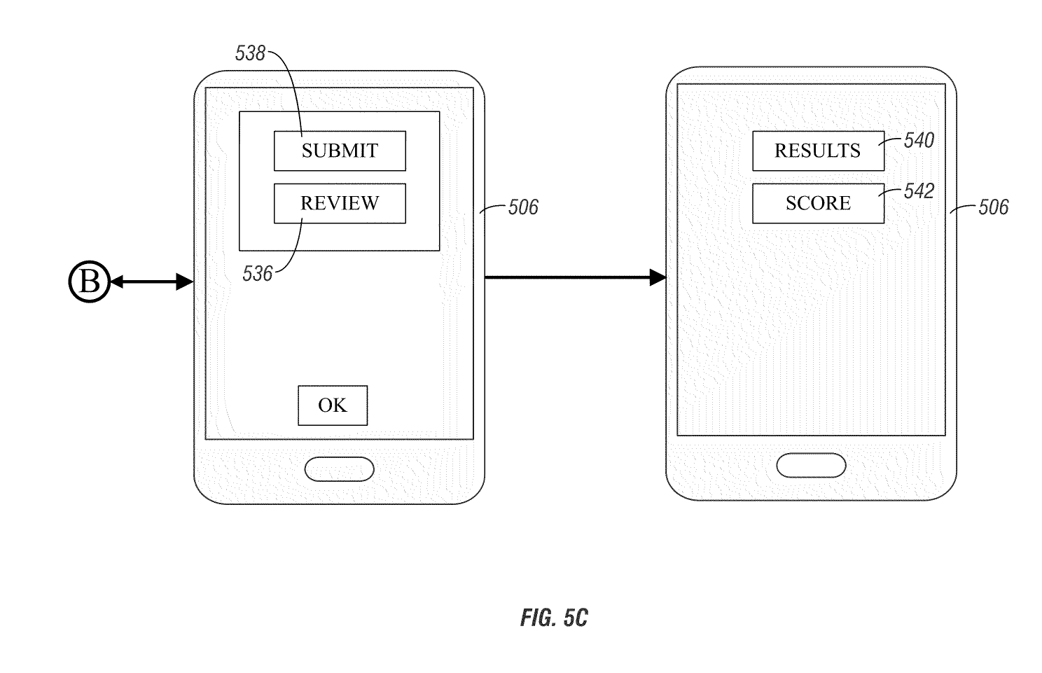

FIGS. 5A-C are pictorial illustrations of an exemplary system 500 in accordance with an illustrative embodiment. As pictorially represented, aspects of the present disclosure leverage existing usage of paper test booklets. This includes, for example, using paper test booklets 504 in combination with an electronic device 506. As discussed above in relation to those elements pictorially represented in FIG. 2, an administrator, proctor or other like personnel may, using an electronic device, create a new test 544, such as computer-based test. The administrator or other like personnel may then, using the electronic device, digitally fill out or complete an electronic solutions sheet 502 or an answer sheet with the correct responses for the test that was created and is associated with the paper test booklet. Once all the answers or solutions have been entered electronically, the administrator or like personnel may select an option to create a CBT. Immediately following or in due course, the administrator or like personnel may select an option to print 508 the test booklet QR code label 510, such as pictorially illustrated in FIGS. 5A-C. The QR code label 510 may then be affixed or adhered to or otherwise associated with the paper test booklet 504 as pictorially represented in FIGS. 5A-C. The paper test booklet 504 with the QR code label 510 is delivered to an Examinee along with an electronic device 506, or the Examinee may use their own electronic device with proprietary software or other operating protocols installed.

The electronic device 506 may be programmed to or by running application 512 request information from the Examinee using, for example, a form 512 that requests information such as the Examinee's first name 514, last name 516, role number 518, hall ticket number 520, subject code 522, date of the examination 524, email ID 526, mobile number 528, etc. Other identifying information may be requested using a protocol, operation or application on the electronic device. Upon entering the requested information, the Examinee may be prompted (e.g., see Tap to Scan Bar Code button 530) to scan the QR code label 510 to identify the specific scoring rules associated with the paper test booklet 504 or scoring. Using the paper test booklet 504 and the electronic device 506, the Examinee enters solutions 502 or responses to the test items in the paper test booklet 504 using the electronic device 506 as pictorially illustrated in FIGS. 5A-C. By way of example, an electronic answer sheet, such as a bubble sheet 532, may be displayed for the Examinee to enter a response 534 based on the test items included in the paper test booklet 504. Displaying the Examinee's responses allows the Examinee to review 536, revise or otherwise check responses entered into the electronic device 506 and displayed by the electronic answer sheet. If satisfied, the Examinee may submit 538 the responses for immediate scoring.

Following the process of submitting the responses, the Examinee may be presented with a metric, results 540 or indication of Examinee's performance for the test items in the paper test booklet. For example, a raw score 542 may be displayed on the electronic device 506. Other information relating to the metrics of the specific test being administered and one or more or a group of test items included in the test booklet may be included for performing an analysis and providing metrics to the Examinee for review in real-time upon submission of his/her responses. The administrator may select or request additional or modified scoring to be completed with the existing item responses submitted in the electronic device (e.g., within the same test or subsequent tests). Capabilities are provided for detailed scoring of individual items, groups of items and for identifying conversions to be used for scaled scores.

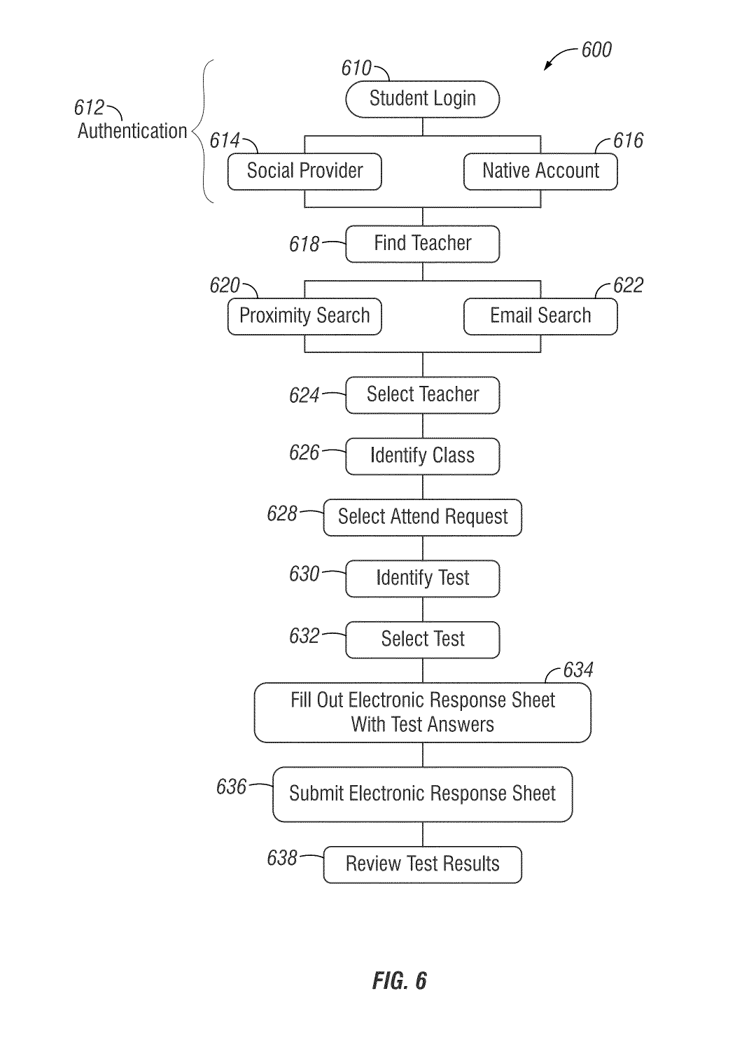

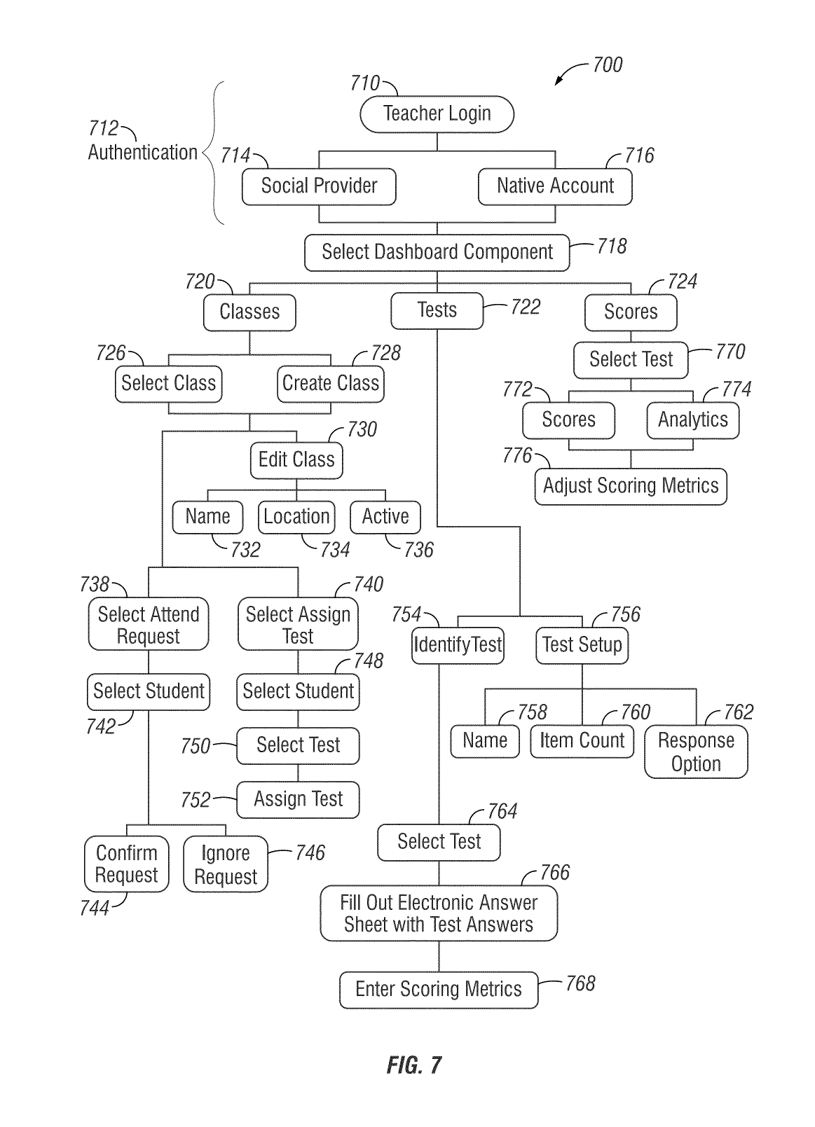

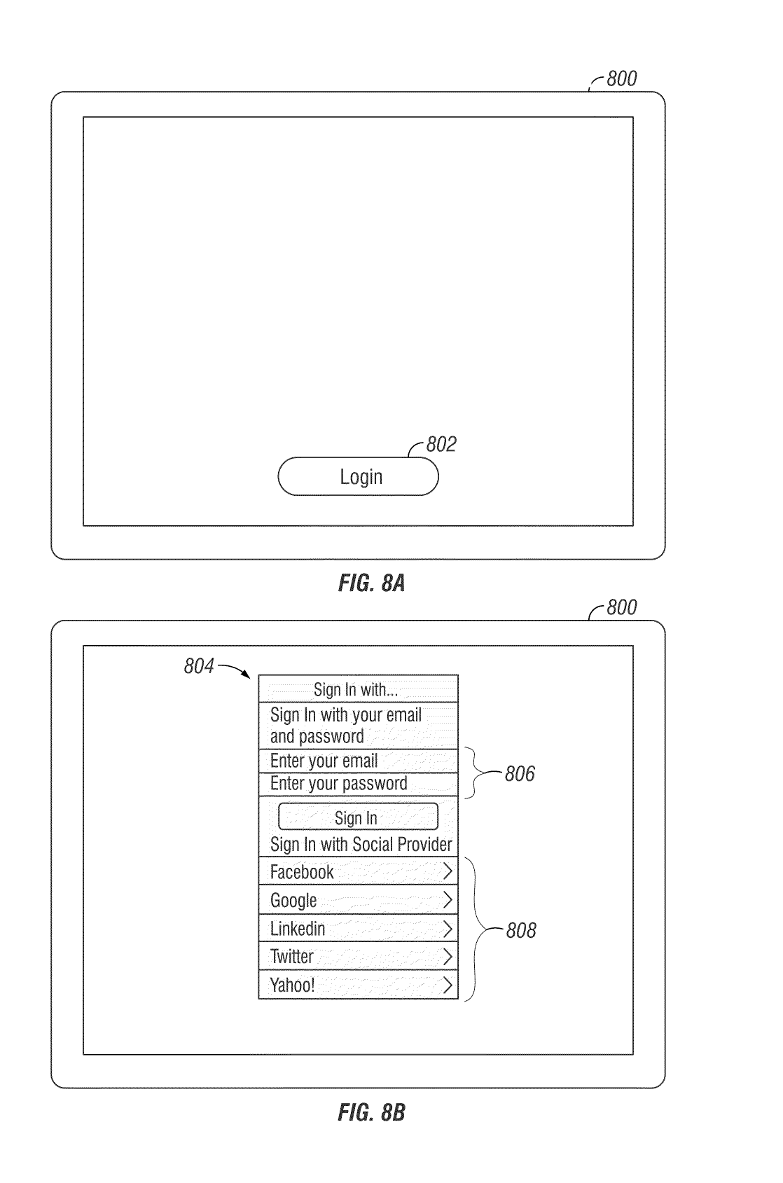

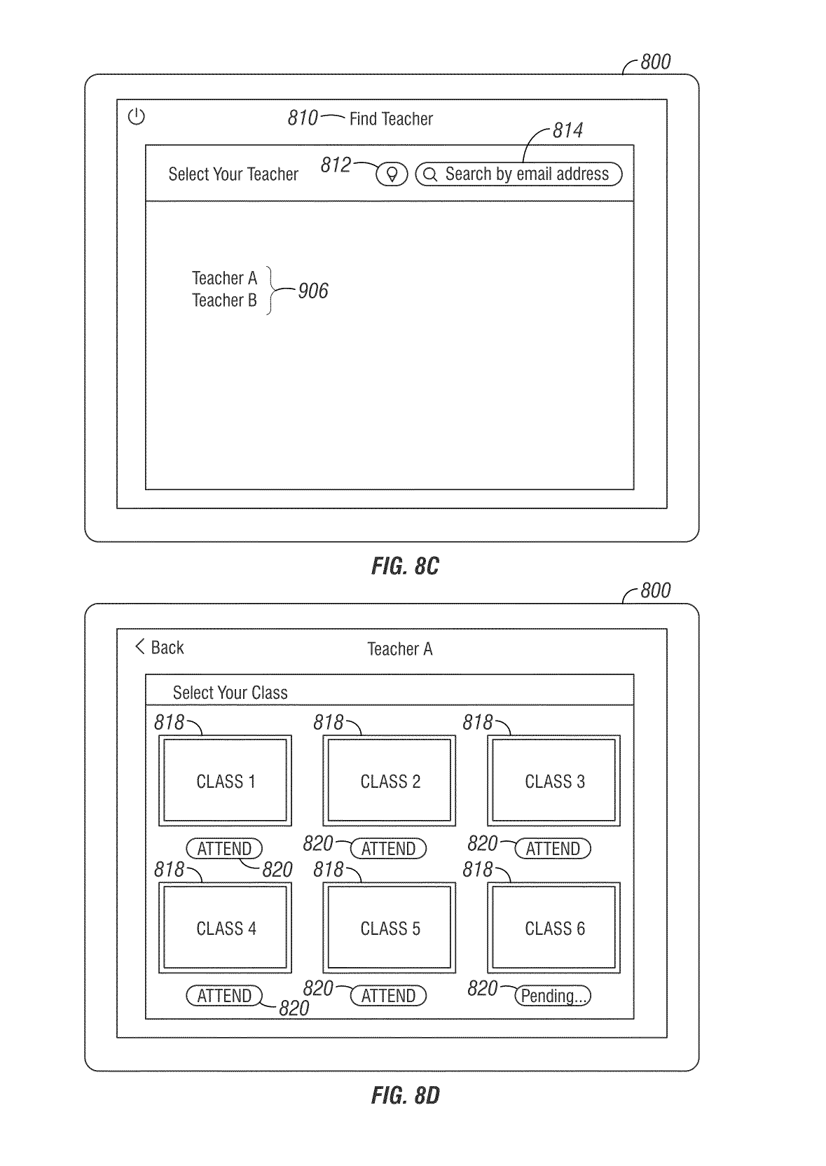

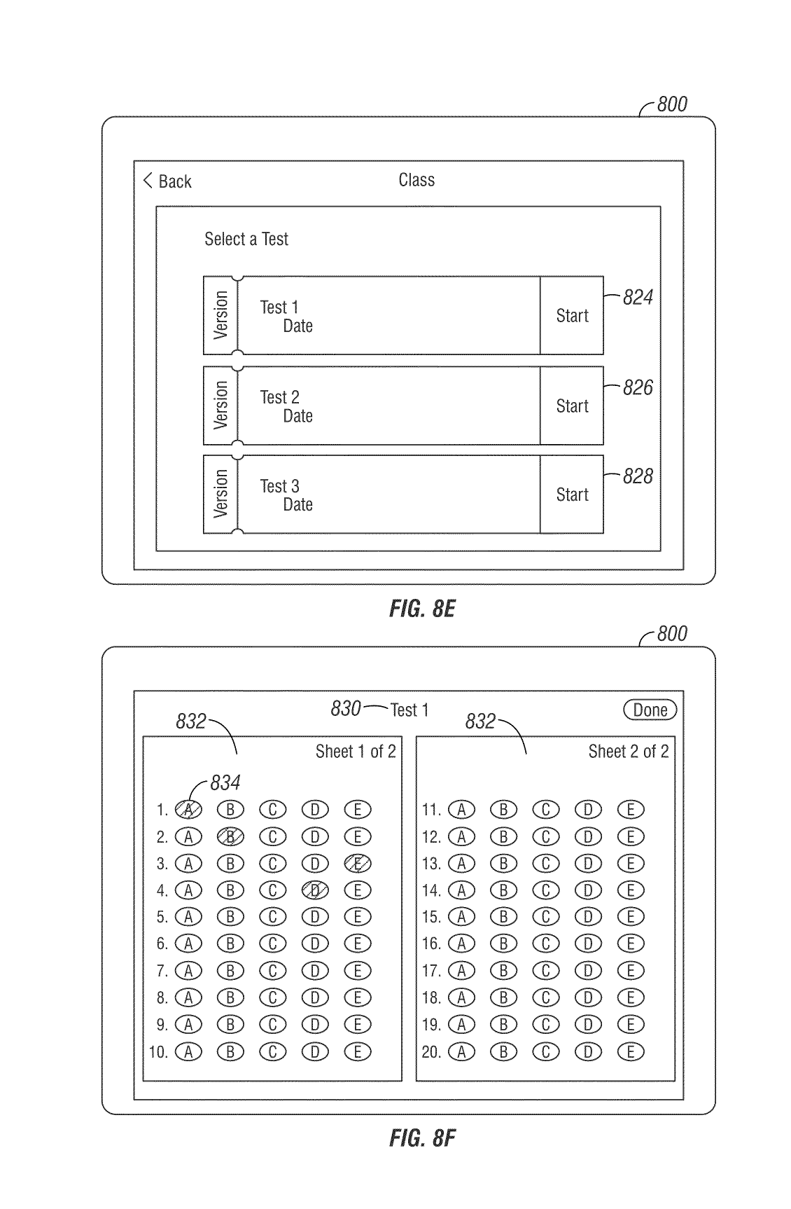

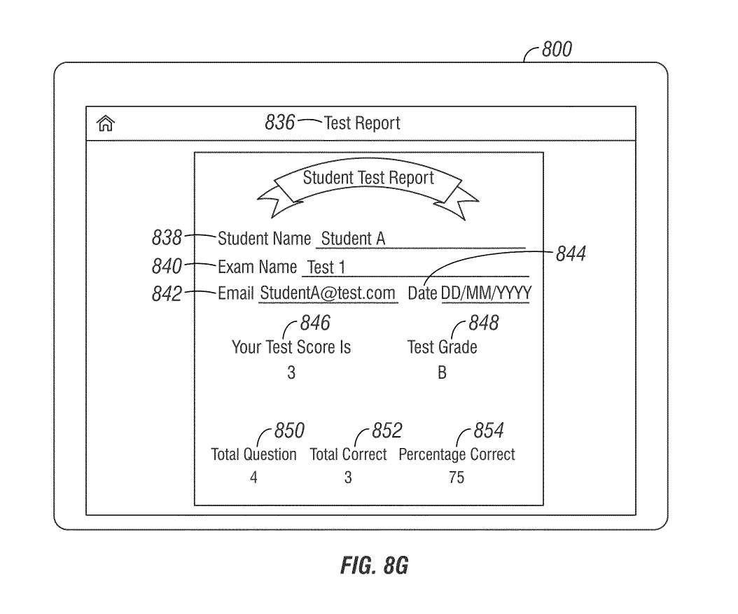

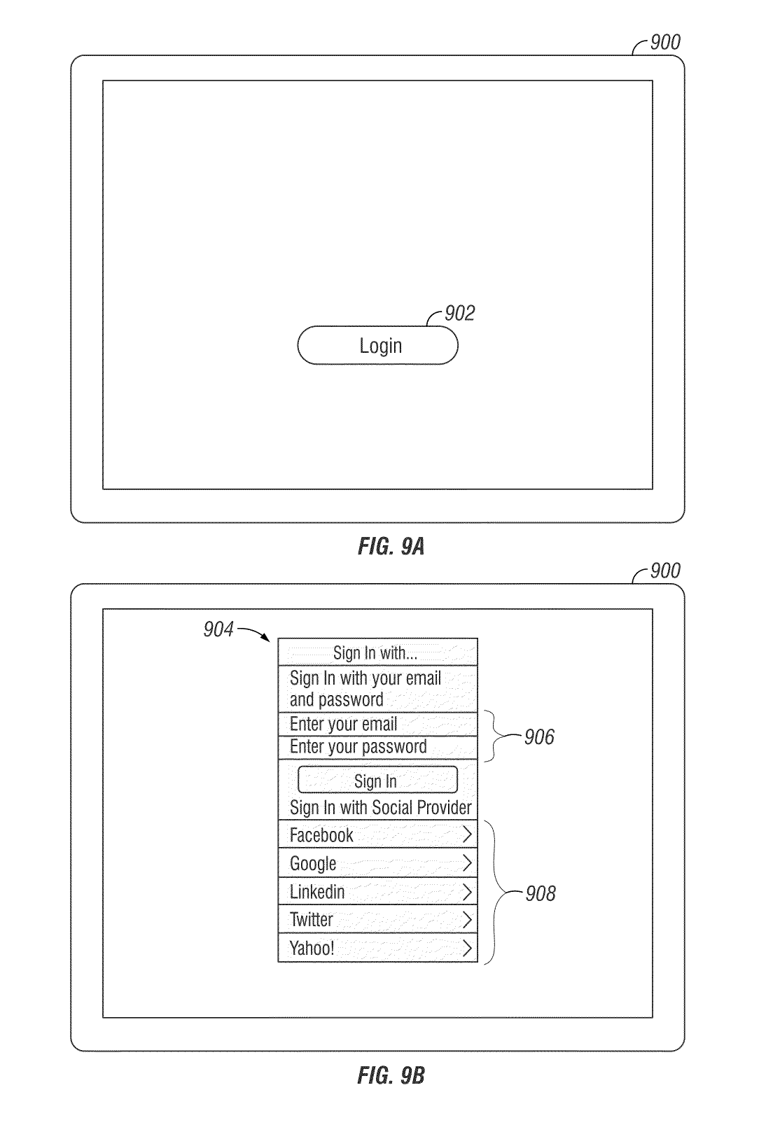

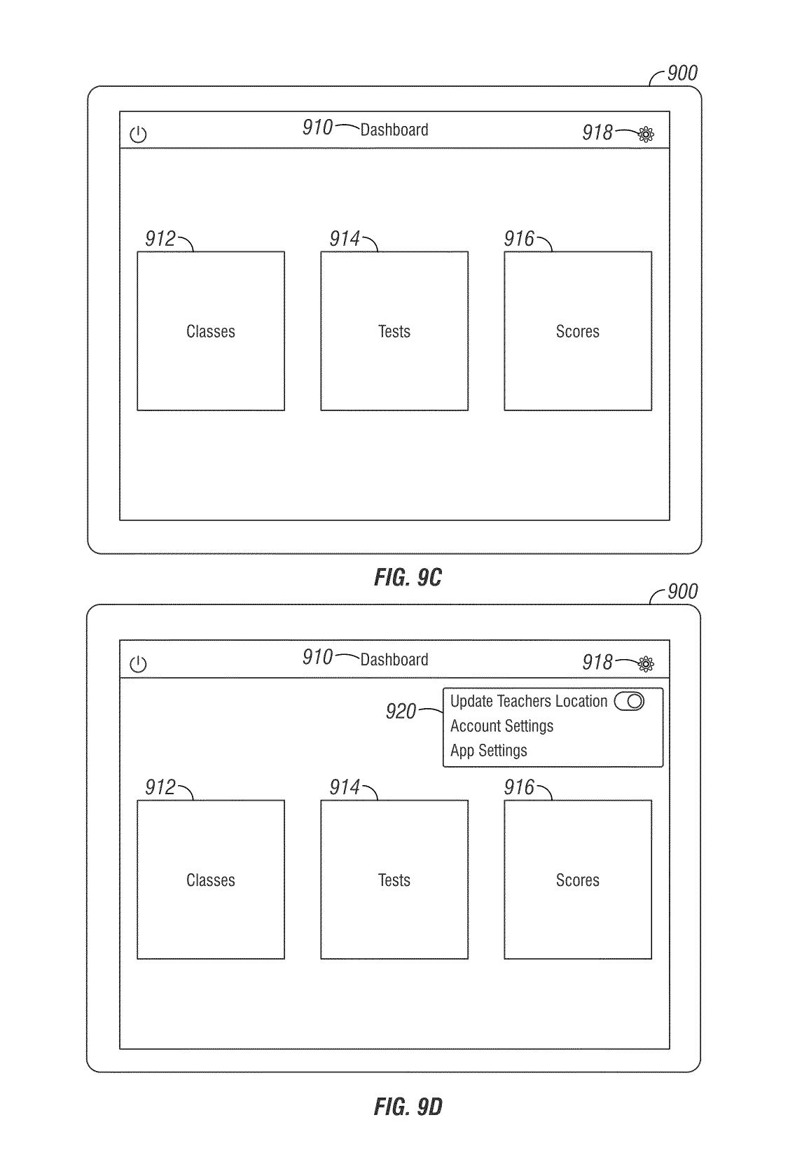

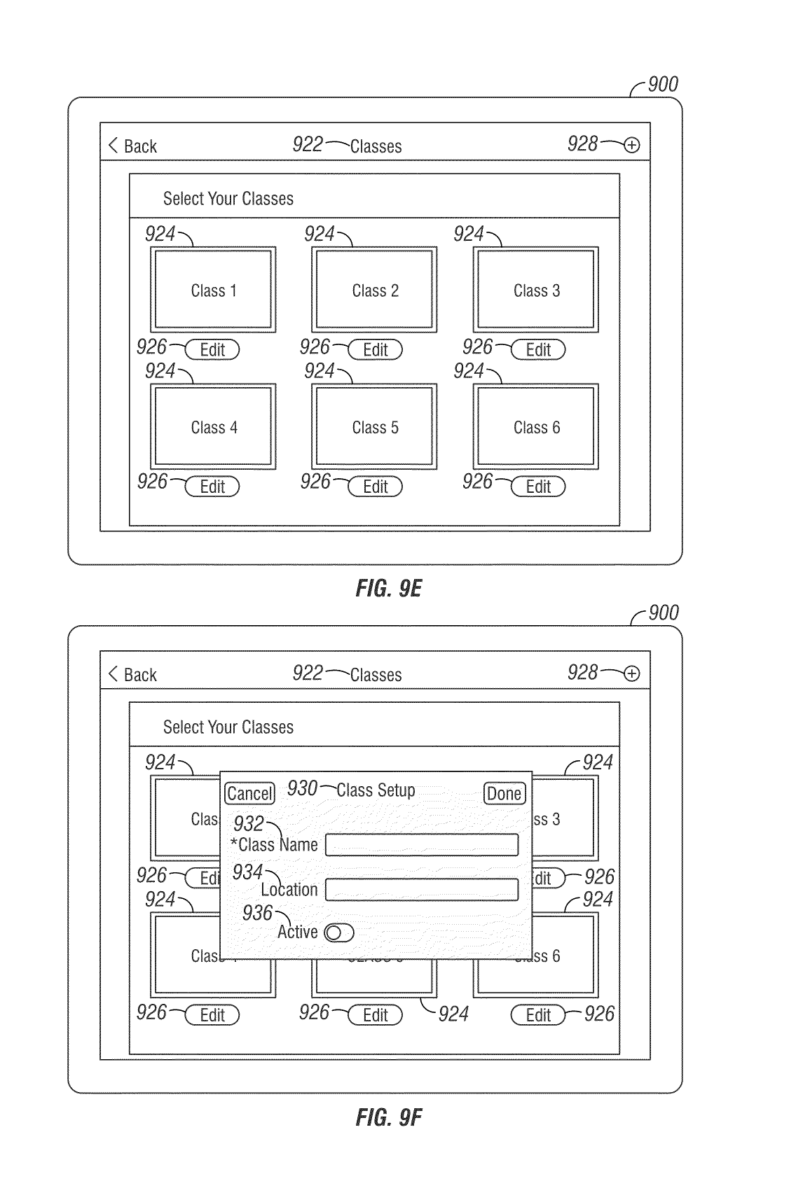

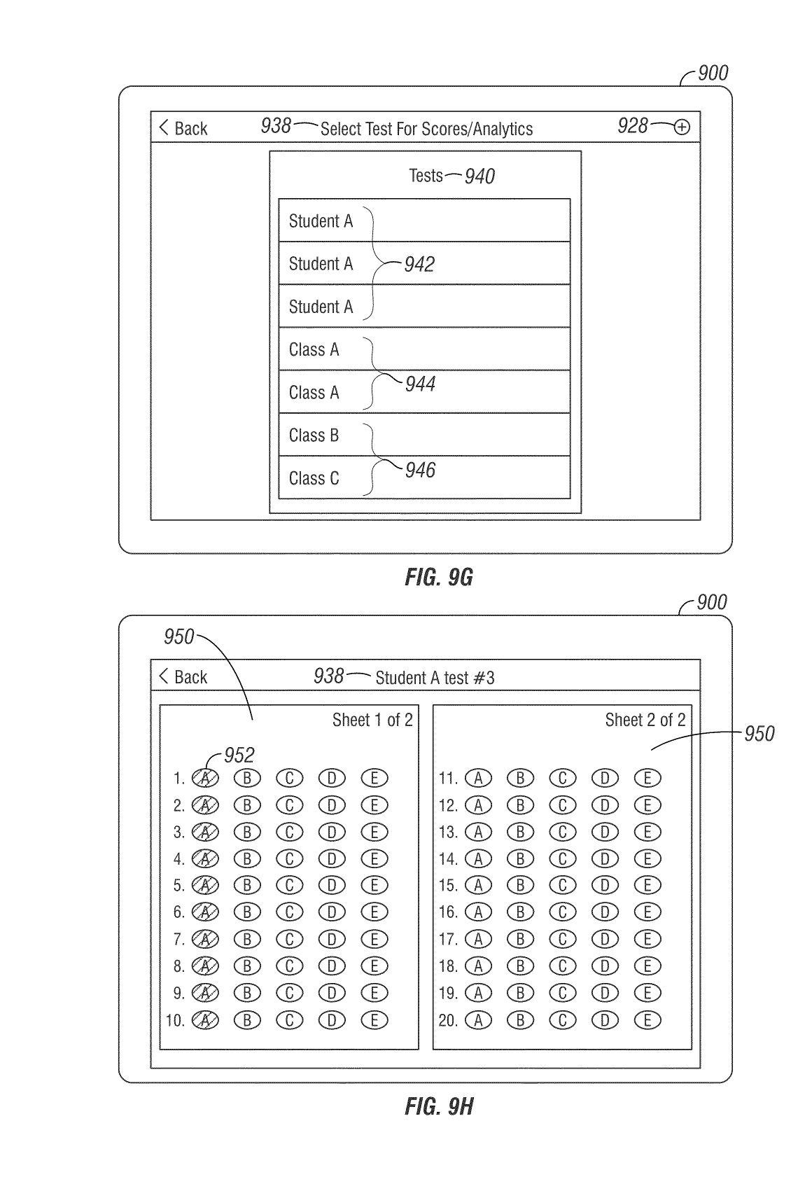

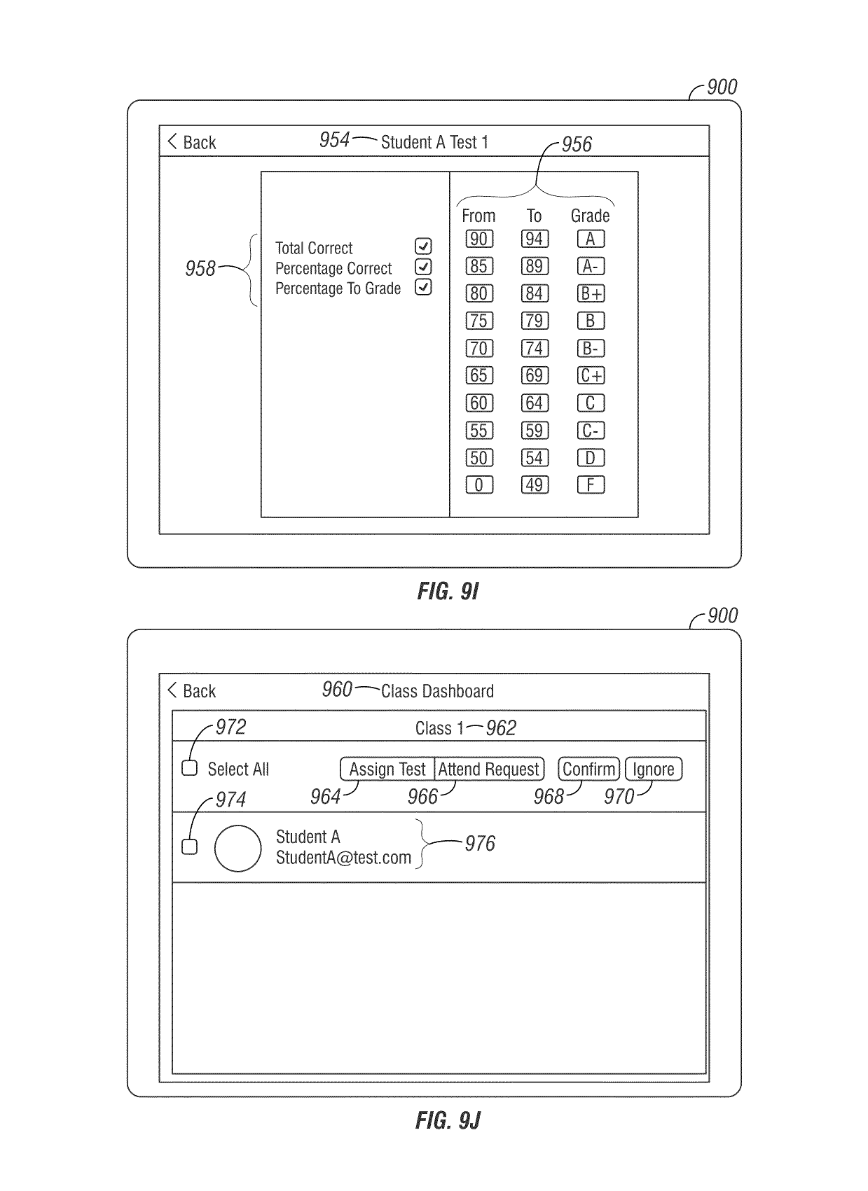

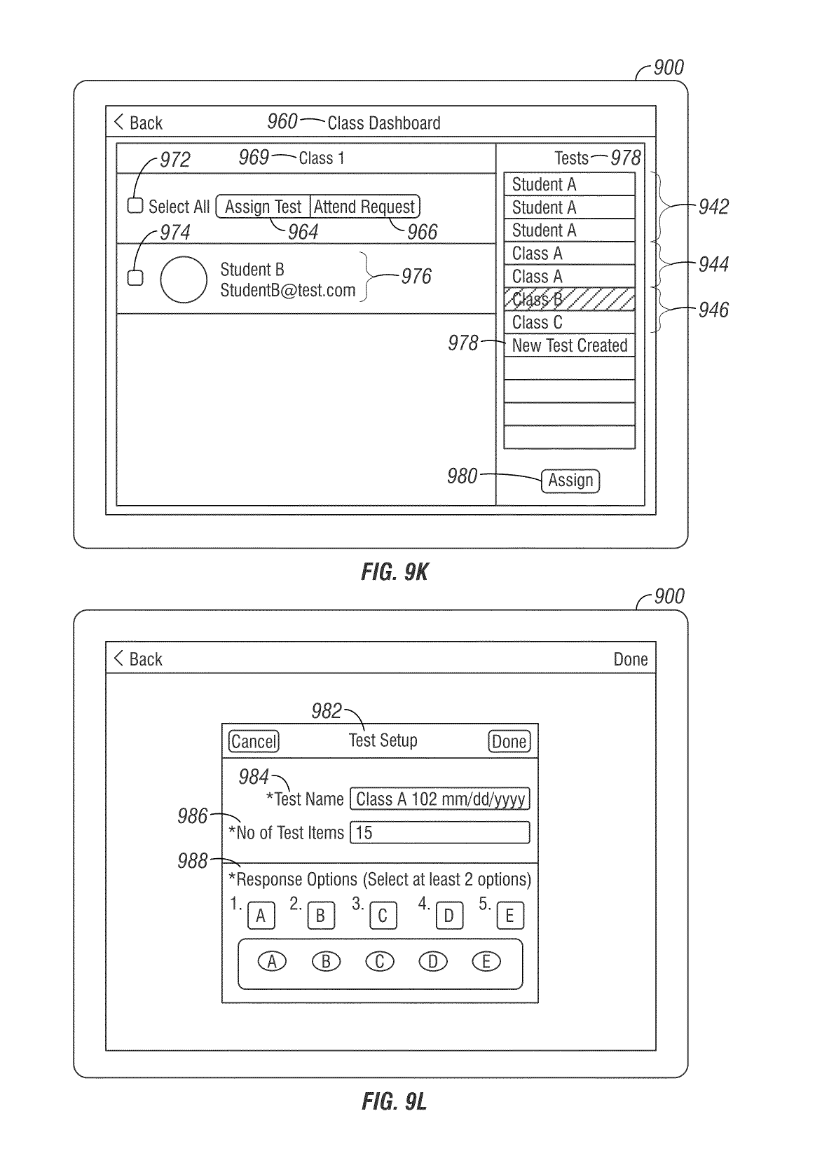

In one aspect the process of associating a student with a specific test is accomplished using a label, such as a QR code, on a test booklet. In another aspect, associating a specific student with a specific test can be accomplished using other authentication processes. FIGS. 6-7 provide a flow diagram for authenticating a specific student with a specific test for the process of converting any tangible/physical test materials, such as a test booklet, overhead projection, or other like non-electronic renderings of a test to a computer based test. Specifically, FIG. 6 provides a flow chart that is pictorially representative of a process 600 for a student in accordance with an exemplary aspect of the present disclosure. FIG. 7 is a flow diagram pictorially representative of a process 700 for a teacher in accordance with an exemplary aspect of the present disclosure. Accompanying screen shots of the process 600 in FIG. 6 are provided as pictorial representations in FIGS. 8A-8G and for the process 700 in FIG. 7 in FIGS. 9A-9L.

Using an electronic device, such as those previously discussed, a student may log in to an application 800 using the process 600 pictorially represented in FIG. 6 and a teacher may log in to an application 900 using the process 700 pictorially represented in FIG. 7. On the front end of each process 600, 700, an authentication protocol 612, 712 is provided to link a student and/or teacher to demographic data associated with the student and/or teacher's account. FIGS. 8A and 9A provide pictorial representations of a log in 802, 902 for respective student log in 610 and teacher log in 710. According to one aspect, the process 600 may include a student log in 610 enabled using a native account 616 or a social provider account 614. Similarly, a teacher log in 710 for the process 700 may be enabled using a native account 716 or a social provider account 714. A screenshot of the application 800 provides a pictorial representation of a signin 804 using, for example, a native account 616 by entering an email address and an accompanying password associated with the email address of a student. A similar teacher log in 710 for the process 700 is provided by application 900 in FIG. 9B, which provides a signin window 904 whereby a teacher may sign in using a native account 716 by entering an email address and accompanying password associated with the email address 906. Alternatively, a teacher may log in to the application 900 using a social provider account 908 such as Facebook, Google, Linked In, Twitter, Yahoo, or any other like social provider account. Thus, authentication 612 in the process 600 and authentication 712 in the process 700 may be accomplished using a native account 616, 716 or social provider account 614, 714 as pictorially represented in the applications 800, 900 and respective FIGS. 8B and 9B. According to one aspect, a commercial product or like commercial products such as those offered by Janrain may be used to link accounts and grant permission to demographic data in each account associated with the student or teacher. Such a provider may be used also to allow students or teachers to log in to social provider accounts such as Facebook, Google, Linked In, Twitter, Yahoo, or other like social provider accounts whereby authentication is handled by such providers using a profile created for each specific student or teacher using an authentication piece such as Janrain that then grants permission to demographic data in the account to authenticate the student log in 610 and teacher log in 710 of respective processes 600, 700. Other platforms, in addition to Janrain, are contemplated but any authentication service provider may be used such as webdesktop or webtop or other like platforms. Thus, authentication 612, 712 using one or more of the aforementioned commercially available products may be used to authenticate the student log in 610 and teacher log in 710 using a social provider account or a native account created using an email address and accompanying password as indicated.

In the process 600, a student is able to find a teacher 618 using a proximity search 620 or email search 622. Application 800 provides a screenshot that is pictorially representative of the aforementioned steps in the process 600. For example, in the Find the Teacher window 810 a student can search for a teacher using a proximity search 812 or search by email address 814. The proximity search 812 is configured to use GPS coordinates to poll teachers within a specific georegion such as 30-40 meters within the proximity of the device on which application 800 is operating. For example, a proximity search 812 may result in an identification of all or some of the teachers within a specific georegion or area, or the ability to find a local teacher. The search for a specific teacher or instructor may also be conducted by entering and searching by an email address 814. Application 900 in FIG. 9D provides a pictorial representation of a window 920 that allows a teacher or instructor to update his or her geolocation, for example, by toggling a button to the on position and turn off his or her geolocation by toggling a button to the off position. In the on position, for example, a proximity search 812 would identify a teacher or instructor within a specific georegion, area or range of the student and his or her device upon which the application 800 is running. FIG. 8C provides a pictorial representation for a list of teachers 906 identified from a proximity search 812 or email address search 814. Thus, the list of teachers 906 may be populated by the application 800 using the find teacher 810 operation.

Upon identifying a specific teacher in the list 906, one of the teachers may be selected 624 in the process 600 from the populated teacher list 906. For instance, if a student selects Teacher A from the list 906 in FIG. 8C, a list of Teacher A classes 818 are provided in the application 800 for the student to select from. Each class 818 may include a class description or other information relevant to the specific class offering. Each class 818 is accompanied with an attend button 820 or in the case where the class 818 has not been finalized, a pending button 820.

In the process 600 a student identifies the particular class 626 and selects an attend request 628. In at least one application 800, a student selects from the classes 818 offered by Teacher A using one of the attend request buttons 820. The list of classes 818 in application 800 shown in FIG. 8D is populated by a teacher using the create class step 728 in process 700 shown in FIG. 7 and pictorially represented by application 900 in FIG. 9F. For example, the process 700 provides a teacher log in 710 using the methods previously described to access the select dashboard component 718 which is pictorially represented in application 900 shown in FIGS. 9C and 9D. The dashboard 910 includes a classes 720, test 722, and score 724 component represented pictorially in application 900 by the classes operation 912, test operation 914 and scores operation 916. A setup button 918 may also be provided to access the update teacher location 920 pictorially represented in FIG. 9D. Other setup parameters may be included such as, for example, account settings and application 900 settings.

In the process 700, the classes 720 provide a select class 726 and create class 728 operation. Application 900 in FIG. 9E provides a pictorial representation for a select class 726 operation; the list of classes 924 populated by those classes being offered by the teacher. An edit class 730 operation accompanies each class 924 pictorially represented in FIG. 9E. The details associated with each particular class, such as name 732, location 734, and whether the class is active 736 are just a few of the fields that may be used to define the list of classes 924 populated in the classes window 922 for the application 900 in FIG. 9E. Upon selecting one of the classes 924 to edit 926, a class setup 930 is provided as pictorially represented in FIG. 9F. The teacher may complete the class setup 930 by entering a class name 932, a location 934 for the class, and toggling the active button 936 on or off. For example, in the case where the active button 936 is toggled off, the class would not necessarily show up in the list of populated classes 818 available to the student to select as pictorially represented in FIG. 8D. For example, with the active switch 936 toggled off the class may show up in a search by student as pending 820 as represented by application 800 in FIG. 8D. Thus the teacher controls the list of classes from which a student selects the class 818 he or she wishes to attend 820 as pictorially represented by application 800 in FIG. 8D. Toggling the active button 936 on and completing the class setup 934 populates the class with the existing list of classes 924 pictorially represented by classes 922 in FIG. 9F. As previously indicated, the student selects a class 818 using attend request 820 which is received by the teacher pictorially represented by the application 900 shown in FIG. 9J. According to one aspect, the class dashboard 960 allows the teacher to select the specific class for which an attend request was submitted by the student; the list of student names in the attend request 966 is populated for example, if Student A selects Class 1 818 by submitting an attend request 820 as pictorially represented in application 800 shown in FIG. 8D, the teacher receives in the attend request for Class 1 962 populated in the list of attend request pictorially represented in application 900 shown in FIG. 9J. In the process 700, the teacher may select the attend request 738 by selecting the student 742 and either confirming the request 744 or ignoring the request 746. This process is pictorially represented by application 900 shown in FIG. 9J. Information 976 regarding the student submitting the attend request may be provided in a populated list for Class 1 962. Information associated with the attend request may include, for example, the student's name, the student's email address, and/or a photograph or picture of the student as may be illustrated in the circle next to or adjacent the student information 976. The check box 974 for an individual student may be checked, or in the case where multiple students are populated in the list for a Class 1 962, the teacher may select all of the students listed by checking the box 972. Upon checking one or more of the students populated in the list of attend requests for Class 1 962, the teacher may be either confirm 968 the attend requests 966 associated with each student or ignore 970 the attend requests 966 associated with each student 976. Thus, a teacher can view a populated list of attend requests submitted by students for each class he or she has created as pictorially represented in FIGS. 9E and 9F. While an attend request is being handled by a teacher, the specific class for which a student submits an attend request may show up in the list of classes 818 populated for that specific teacher as pictorially represented by application 800 in FIG. 8D as pending 820. Upon the teacher confirming 968 the attend request 966, the status of attend request may be indicated as no long pending or otherwise enrolled. Upon being enrolled in the class, the student is able to see the test currently being offered for that particular class as pictorially represented by application 800 in FIG. 8E. Thus, for example, upon the student identifying the class 626 and selecting an attend request 628 as represented in the process 600 in FIG. 6, the student may select a test 632 populated in the list of tests shown in application 800 in FIG. 8E. In one aspect, the list of tests may be populated by exemplary Test 1 824, Test 2 826 and Test 3 828. Any number of tests may be listed and populated for viewing by the student. A scroll function may be included for additional viewing area for the student to be able to view more tests being offered for a particular class than may be illustrated pictorially by the application 800 in FIG. 8E.

In the process 600, the student selects a test 632 from the list of tests 824, 826, and 828. Before the list of tests can be populated for the student to view, the teacher using process 700 from the select dashboard component 718 selects a test operation 722 whereby the teacher may identify a test 754 or perform a test setup 756. A pictorial representation of the process is provided by application 900 in FIGS. 9J, 9K and 9L. Thus, a teacher can select a specific class 969 and manage attend requests for that particular class received from students as well as assign specific tests 964 to specific students for that particular class 969. Thus, in addition to processing an attend request 966 for each of the students listed or populated in the student listing 976 as pictorially represented in FIG. 9J, the teacher may assign tests 964 to a particular student 976 within the list of students.

In the process 700, a teacher may select assigned test 740, select a specific student 748, select a specific test 750 and assign that specific test 752 to the selected student 748. Upon selecting a specific student from the populated list of students, the teacher may select assigned test 964. In one example, the teacher may select individual or all students populated in the list for Class 1 962. This would be the same for any other class, such as, Class 2, Class 3, Class 4, Class 5, Class 6, and so forth. This can be accomplished using the select button 974 for a specific student or a specific batch of students or select all button 972 for selecting all students populated in the list for a specific class, such as Class 1 962. Upon selecting the assigned test 964, a list of tests 978 is populated for the teacher to select test 750 and assign test 752 as represented in the process 700 in FIG. 7. The list of tests 978 as pictorially represented in application 900 shown in FIG. 9K may include a set of tests for a specific student, a specific class, a specific subject matter, or any of the like. For example, the list of test 978 includes, only by way of example, a number of tests 942 for Student A, a number of tests 944 for Class A, and another set of tests 946 for Classes B and C. The teacher may select from one of the existing test 978 in the list and assign 980 the test to a specific student in the list of students 976 populated in the class dashboard 960 for Class 1 969. In one aspect, a teacher may select from the list of tests 978 test 942 for Student A and assign 980 the list of tests 942 for Student A to Student A. Upon Student A selecting the teacher form the list of teachers 906 in FIG. 8C and Class 1 818 from the list of classes, a list of test 942 assigned to Student A are populated in the application 800 shown in FIG. 8E. The list of tests show up as Test 1 824, Test 2 826 and Test 3 828. From the list of tests populated, the student may select a test to take. These tests are assigned to the student by the teacher using the assign test 752 for the process 700 pictorially represented in FIG. 7. In another aspect, the teacher may select Class B from the classes 946 and assign 980 Class B to Student B 976 by selecting the box 974 and Class B from the list of class 946 and the assign 980 as pictorially represented in FIG. 9K for application 900. Optionally, the teacher may create a new test 978 by performing a test setup 756 operation in the process 700. The test setup 756 may include defining such parameters as the name 758, the item count 760 for the test and the response option 762 for the test. Other criteria may also be included in the test setup 756 for defining features, parameters and particulars for each test. An exemplary pictorial representation is provided by application 900 in FIG. 9L for a test setup 982. As indicated, the test setup 982 may include one or more fields or inputs, such as a test name 984, where the instructor may include a name of the test for a specific class and a test date or other defining information. The test setup 982 may also include an option to define the number of test items 986 for the particular test and the type of response options 988 for the particular test. For example, one test may include three response options such as A, B, and C, whereas another test may include five response options A, B, C, D, and E. Once the test setup 982 is complete, the teacher may select done to add it to the list of defined tests in the list of tests 978 represented pictorially in FIG. 9K. From a newly created test 978 or an existing test 942, 944, or 946 from the list of test 978, a teacher may select a test 764 as represented in the process 700 in FIG. 7 from the list to fill out an electronic answer sheet with test answers as provided in step 766 and further defined the scoring metrics for the particular test as defined in step 768 of the process 700.

The list of tests 940 may be populated in application 900 as pictorially represented in FIG. 9G. The list of tests 940 may include the test 942 for Student A, test 944 for Class A, and test 946 for Classes B and C. Using the add test button 928, the teacher may add additional test 940 to the list. By selecting one of the tests for score and analytics 938 as pictorially represented in FIG. 9G or identifying one of the tests 978 from the list pictorially represented in application 900 in FIG. 9K, the teacher may select a specific test 764 in the process 700 to fill out an electronic answer sheet with test answers 766 as pictorially represented by application 900 in FIG. 9H. Using a non-electronic format of a test, such as a test booklet, an overhead projection, a written test or other non-electronic formats, a teacher may fill out the answer sheet 950 with the correct answers 952 for a test that is administered using, for example, a test booklet or a paper administrated test, or a test provided to a classroom via an overhead projector or via some display. The electronic answer sheet may be in the form of an electronic bubble sheet. The application 900 in FIG. 9H may include a scroll feature to scroll through the various sheets. Thus, the teacher fills out the electronic answer sheet with the correct answers associated with a specific test that may be administered by the teacher, for example, by handing out a test booklet.

The scores 724 in the process 700 may be adjusted by selected a test 770 from the list of tests 940 pictorially represented in FIG. 9G and changing the scores 772 or the analytics 774 by adjusting the scoring metrics 776. FIG. 9I provides a pictorial representation for some exemplary scoring metrics associated with Student A, Test 1 954 and a grading scale 956 also associated with Student A, Test 1 954. The grading metrics 958 may include, for example, such metrics or indicators as total correct, percentage correct and/or percentage to grade. The grading scale 956 may be defined by the instructor and the scores 724 component of the process 700. Upon the student selecting one of the tests from the list of tests 824, 826, and 828 pictorially represented by application 800 in FIG. 8E, an electronic response sheet is provided to the student to fill out with test answers in accordance with step 634 of the process 600 shown in FIG. 6. The electronic response sheet provided by application 800 in FIG. 8F includes such information as the test 830 selected by the student for which the response sheet with test answers corresponds. Each response sheet 832 includes electronic responses 834, such as in the form of an electronic bubble sheet. A scroll function may be included for additional sheets. The questions corresponding to the electronic response sheet are provided to the student in a test booklet, according to at least one aspect. In another aspect, the test questions for completing the electronic response sheet may be provided to the student by an overhead projection of the test within a classroom. In another aspect, the test questions for completing the electronic response sheet with test answers may be provided to the student by some other display or handout. The student completes the electronic response sheet with test answers for the questions within the booklet or other format of the test questions provided to the student by the teacher or some other provider which is then proxied by the teacher. In this manner, questions presented in a test booklet are converted to computer based testing by completing the electronic response sheet with test answers in the application 800 pictorially represented in FIG. 8F.

Upon completion of the test, the student submits the electronic response sheet 636 in the process 600 to review test results 638. Application 800 pictorially represented in FIG. 8G provides a representation of a test report 836 for a student submitted test. The test report 836 may include such information as student 838, exam name 840, an email address 842 for the student and a date 844 for the examination. Other information included in the test report 836 may be a test score 846 and test grade 848. Other metrics associated with the test report 836, for example, may include the number of test questions 850, the total correct 852 and the percentage correct 854 for the exam name 840. Upon completion and submission of a test, the teacher may in the process 700 select the specific test 770 and run analytics 774 for adjusting scoring metrics 776, scores 772 or other details relating to scoring and the results for scores 724 in the process 700. This can be done, for example, using the application 900 pictorially represented in FIG. 9I. In one aspect, the teacher may adjust the scoring metrics associated with a specific test using the scoring metrics 958 or a grading scale 956. The analytics 774, scores 772 and adjust scoring metrics 776 of the process 700 allows the teacher to change the conversions and other scoring algorithms associated with a specific test or group of tests.

Beneficially, the student requests attendance to a specific class and the teacher confirms attendance providing a two-way request and confirmation. In another aspect, the teacher may administer a test that the teacher is not required to create a test or an answer sheet for but simply provides or creates through registration process for the test using the applications and processes provided herein. The applications and processes provided herein provide the ability to do summative scoring. For example, in the case where common core were implemented across the fifty states, a math mastery quiz could be used to rank students against a national norm or average using the applications and processes of the present disclosure. Applications and processes of the present disclosure also provide instant feedback regarding test performance and results, allow for handling groups of students and rapidly transitioning “pencil and paper” information to computer based testing, computer based collection of information and computer based analytics of the collected information. Other advantages include the ability for teacher to create classes, tests, and registrations from virtually anywhere. For example, a teacher can sit at home and create a pop quiz and send registrations out for the pop quiz. The quiz can be handed out to the class in a quiz booklet or display the quiz on an overhead projector and the students enter the answers to the quiz in the electronic answer sheet as previously described. This allows the teacher to have the freedom to roam about the testing environment by handling a lot of the registration, creation and administration processes in advance of the actual quiz. Aspects and processes of the present disclosure also provide a teacher with the ability to look at any given test in a class administer a quiz, and instantly verify comprehension and identify a student or students who may be struggling or who did not correctly answer a specific question. This may allow a teacher to quickly identify concepts which one or more students within a classroom are struggling with a test question which one or more students in a classroom are having a difficult time understanding or otherwise may be confusing. Other aspects of the present disclosure allow a student to take, for example, the same test more than once (e.g., two, three or four times) and the registration for each test is based on a time date stamp, which is unique to each specific test. Thus, an electronic registration as described herein is unique to each specific test being administered with a time and date stamp providing one way of distinguishing and making each test and electronic registration unique. The present disclosure contemplates converting various types of item content forms. For example, item content forms may include a test booklet or other images projected for viewing by a student or number of students in a testing environment such as by an overhead projector or display. In this manner, the teacher creates and electronic registration based on these types of item content forms, such as a test booklet. The applications, processes and systems of the present disclosure provide the ability for a teacher to create a test and answer sheet in real time and assign the test in real time and create an electronic registration for student in real time.

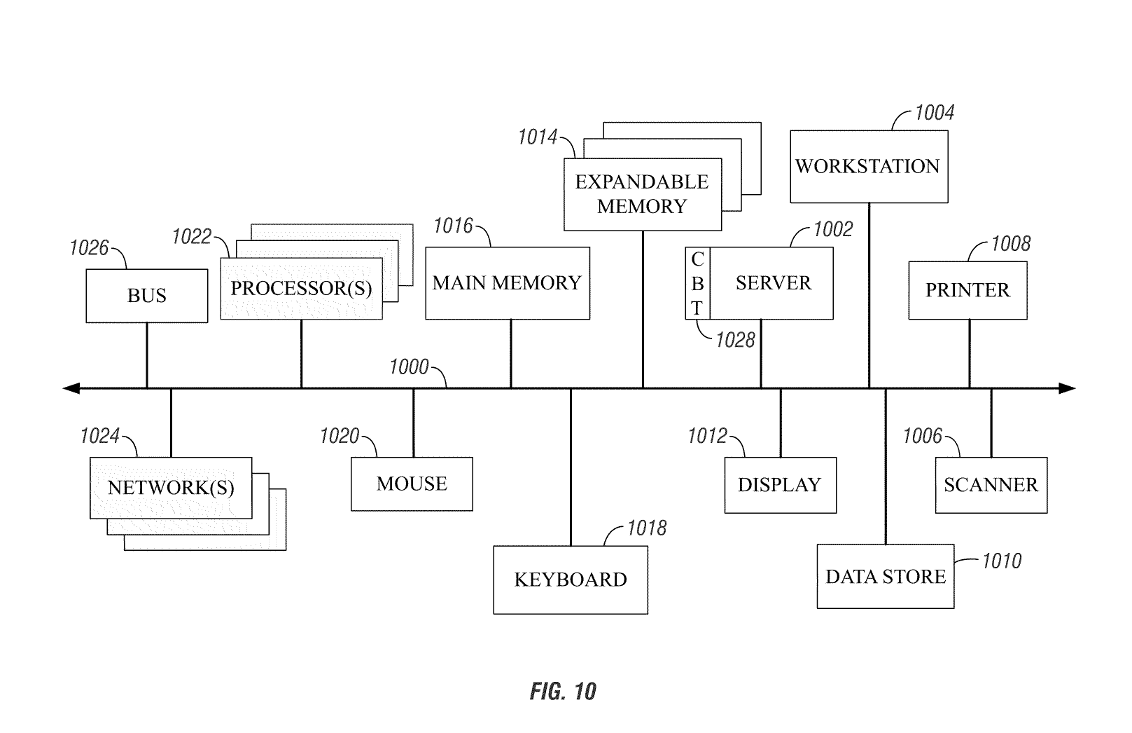

FIG. 10 is a block diagram pictorially representing a computer network 1000 in which the disclosed embodiment of CBT 1028 for the present invention may be implemented. As shown in FIG. 10, the computer network 1000 includes, for example a server 1002, workstation 1004, scanner 1006, printer 1008, data store 1010, an expandable memory 1014, display 1012, keyboard 1018, main memory 1016, processors 1022, bus 1026, mouse 1020, and other like networks. The computer networks are configured to provide a communication path for each device of the computer network to communicate with other like devices. Additionally, the computer networks 1024 may be the internet, a public switchable telephone network, a local area network, private wide area network, wireless network, or any of the like for communicating with an electronic device of the present invention. In various embodiments of the disclosure, one or more of the automated electronic operations using the electronic device, QR code label 510, authentication processes, scoring protocols or other like operations may be executed locally on the electronic device or on a server 1002 and/or workstation 1004. For example, in one embodiment of the disclosure, the server 1002 may be configured to execute any one or more of the protocols, processes or operations of this disclosure, provide outputs for display on the electronic device and receive inputs from the electronic device. In various other embodiments, the electronic device may be configured to execute any one or more operations associated with administering a test electronically or receiving responses to an exam electronically from a paper-delivered test booklet or cooperatively with one or more other electronic devices, computers, or workstations. A scanner 1006 may be configured to scan textual content and output the content into a computer readable format for one or more operations of the disclosure. Additionally, the printer 1008 may be configured to output the content from one or more operations of the disclosure, such as outputting a paper test, QR code label 510, a score report, and scoring metrics on a media, such as paper. Furthermore, data associated with one or more operations of the present disclosure may be stored on a data store. The data store may be a local or a remote data store and may additionally be configured to receive and/or forward some or all of the stored data relating to an operation of the present disclosure. Moreover, in yet another embodiment, some or all of the operations, processes or procedures of the present disclosure may be subsumed within a single device, such as an electronic device.

Although FIG. 10 depicts a computer network, it is understood that the disclosure is not limited to operation with a computer network, but rather, the disclosure may be practiced in any suitable electronic device. Accordingly, the computer network depicted in FIG. 10 is for illustrative purposes only and thus is not meant to limit the disclosure in any respect.

The present disclosure is not to be limited to the particular embodiments described herein. In particular, the present disclosure contemplates numerous variations in the type of electronic devices, whether the information (i.e., data) is stored locally or remotely, whether operations of the disclosure are processed remotely or locally, or the like. The disclosure is not limited to particular types of an electronic device. The present disclosure also contemplates variations in particular types of protocols, operating procedures or processes that may be used for developing the grading metrics, grade scaling or other like operations. One skilled in the art having the benefit of this disclosure will understand that there are numerous other variations of the present disclosure not articulated here, but nevertheless within the spirit and scope of the disclosure.

The present disclosure contemplates numerous variations in the type of ways in which embodiments of the disclosure may be implied to methods and systems for testing with test booklets and electronic devices. The foregoing description has been presented for purposes of illustration and description. It is not intended to be an exhaustive list or limit any of the disclosure to the precise form disclosed. It is contemplated that other alternatives or exemplary aspects are considered included in the disclosure. The descriptions herein are merely examples of embodiments, processes or methods of the disclosure. It is understood that any other modifications, substitutions, and/or additions may be made, which are within the intended spirit and scope of the disclosure. For the foregoing, it can be seen that the disclosure accomplishes at least all of its intended objectives.

The previous detailed description is of a small number of embodiments for implementing the disclosure and is not intended to be a limiting scope. The following claims set forth a number of embodiments of the disclosure disclosed with greater particularity.

What is claimed is:

1. A computer-assisted testing method comprising:
providing a paper exam;
creating an electronic answer sheet;
entering solutions for the paper exam into the electronic answer sheet;
processing an electronic attendance request for providing access to an electronic response sheet; and
answering test items from the paper exam in the electronic response sheet.

2. The computer-assisted testing method of claim 1 further comprising:
creating a new electronic test from the paper exam and the electronic answer sheet.

3. The computer-assisted testing method of claim 1 further comprising:
accessing the electronic answer sheet with an electronic device.

4. The computer-assisted testing method of claim 1 further comprising:
confirming the electronic attendance request for granting access to a class.

5. The computer-assisted testing method of claim 1 further comprising:
selecting the electronic response sheet from an electronic list of one or more of the paper exams.

6. The computer-assisted testing method of claim 1 wherein the paper exam comprises:
a. an examination booklet; and
b. a plurality of test items.

7. A computer-assisted testing method comprising:
providing one or more tangible item content forms of an exam;
accessing an electronic answer sheet for the exam by submitting an electronic attend request; and
entering answers to item content from the exam into the electronic answer sheet.

8. The computer-assisted testing method of claim 7 further comprising:
using an electronic device to access the electronic answer sheet associated with the exam.

9. The computer-assisted testing method of claim 7 further comprising:
authenticating a log in profile for a user submitting the electronic attend request.

10. The computer-assisted testing method of claim 9 further comprising:
capturing answers for item content in the paper exam with an electronic device having the electronic answer sheet.

11. The computer-assisted testing method of claim 7 wherein the paper exam comprises:
a. an examination booklet; and
b. a plurality of test items.

12. The computer-assisted testing method of claim 7 further comprising:
confirming the electronic attendance request for granting attendance in a class to one or more of the electronic answer sheets corresponding to one or more of the exams.

13. The computer-assisted testing method of claim 7 further comprising:
authenticating a log in profile for a user submitting the electronic attend request.

14. A computer-assisted testing method comprising:
providing a paper-delivered exam comprising:
a. an examination booklet; and
b. a plurality of test items;
entering solutions into an electronic answer sheet for the plurality of test items in the paper-delivered examination booklet;
confirming an electronic attendance request from a student;
granting the student access to an electronic response sheet corresponding to the paper-delivered exam; and
receiving student responses to the plurality of test items in the paper-delivered exam in the electronic response sheet.

15. The computer-assisted testing method of claim 14 further comprising:
acquiring solutions entered into the electronic answer sheet with an electronic device.

16. The computer-assisted testing method of claim 14 further comprising:
creating a new electronic test from the paper-delivered exam and the electronic answer sheet.

17. The computer-assisted testing method of claim 14 further comprising:
acquiring the electronic answer sheet with an electronic device.

18. The computer-assisted testing method of claim 14 further comprising:
comparing student responses entered into the electronic response sheet against the solutions entered into the electronic answer sheet.

19. The computer-assisted testing method of claim 14 further comprising:
authenticating a user profile with the student submitted electronic attendance request.

20. The computer-assisted testing method of claim 14 further comprising:
electronically scoring student response submissions in the electronic response sheet to the one or more paper exam questions with the solutions entered into the electronic answer sheet.
